(19) United States
(12) Patent Application Publication
(10) Pub. No.: US 2004/0168283 A1
(43) Pub. Date: Sep. 2, 2004

(54) Controlled caster wheel

(76) Inventor: Tillman Wade Branham SR., Gaston, SC (US)

Correspondence Address: Tillman Wade Branham, Sr., 1012 Brown Blvd., Lexington, SC, 29073, US

(21) Appl. No.: 10/376,201

(22) Filed: Feb. 28, 2003

(51) Int. Cl. B60B 33/00

(52) U.S. Cl. 16/29

(57) ABSTRACT

A controlled caster wheel assembly which can be universally adapted to various support and directional control applications. The control mechanism is the caster beam assembly which attaches to a caster wheel assembly. The caster beam assemblies have both a cam/cam follower mechanism and a weight sensitive clutching mechanism which stabilize the caster wheel assembly thus preventing indiscriminate motion of wheel due to tire to contact surface variations. The controlled caster wheel assembly can be universally applied to any design which uses single or multiple wheels as support and directional control.

### FIELD OF INVENTION

The present invention applies generally to the use of caster wheels, but more specifically to the control and prevention of caster wheel indiscriminate movement.

### BACKGROUND OF THE INVENTION

Caster wheel uses and methods of controlling caster wheel movement have been developed over many years. Indiscriminate caster wheel movement can be best illustrated when using a grocery shopping cart. Most everyone has experienced when using a grocery cart, the inherent wheel shake of the front caster wheels.

Caster wheel control mechanisms are typically applied to trailer apparatuses. One example of said method is disclosed in U.S. Pat. No. 4,512,593 to Ehrhardt. This patented tracking trailer uses dependently supported caster wheel assemblies controlled by being interconnected. Thus, the interconnection has a frictional brake mechanism to control indiscriminate free rotation of the caster.

U.S. Pat. No. 6,042,135 to Ross discloses an anti-pivot braking mechanism used on a hitch and trailer apparatus having steerable caster wheels. Again, this application uses interconnected caster wheel assemblies. The problems with controlling indiscriminate caster wheel motion as described in these disclosures are two fold. First, wheels follow different radii when traveling through curves in road conditions. Thus, by interconnecting two free caster wheels, each wheel will be obligated to follow different paths and tend to fight each other for steering control. The second more obvious problem is that these disclosures cannot prevent the indiscriminate motion on a single wheel design.

### BRIEF SUMMARY OF INVENTION

This invention provides an apparatus for preventing indiscriminate caster wheel motion while tracking various contact surface conditions. This invention is applicable to all caster wheel uses through a full range of wheel speed variations. The apparatus can be readily adapted to any design which uses caster wheels.

The apparatus has a frictional clutching mechanism having hardened clutch plates. The clutching mechanism is designed in a way which applies additional frictional resistance within the clutch as more weight is being carried by the caster wheel.

The apparatus also has an adjustable cam/cam follower mechanism. The cam itself is connected to the main support spindle in which the caster wheel revolves. The cam follower is spring loaded with full range of adjustment on the spring tension. The cam/cam follower is setup to present additional resistance to caster rotation thus allowing the wheel to track it's most common path of center line to travel direction. Also, the resistance to caster rotation is increased through a range of angler rotational degrees based on the design of the cam.

With this invention, indiscriminate caster rotation is controlled through the use of said cam and clutch mechanisms. The stated advantages of this invention are applicable to varying caster sizes, speeds of tire rotation, and load weights being carried by the controlled caster assembly.

### BRIEF DESCRIPTION OF DRAWINGS

FIG. 1 is a perspective view of the controlled caster wheel, illustrated with a partial exploded view of the cam/cam follower and clutching component parts as they would be assembled.

FIG. 2A is a plain view of the controlled caster wheel assembly of FIG. 1 illustrating caster 360 degree clockwise and counterclockwise rotation.

FIG. 2A also illustrates the parting line of the cross section view of FIG. 3.

FIG. 2B is a end view of the controlled caster wheel assembly of FIG. 2A.

FIG. 2C is a side view of the controlled caster wheel assembly of FIG. 2A illustrating tire and wheel rotation.

FIG. 3 is a cross section view of the controlled caster wheel assembly illustrating cam/cam follower and clutching mechanisms.

### DETAILED DESCRIPTION OF THE INVENTION

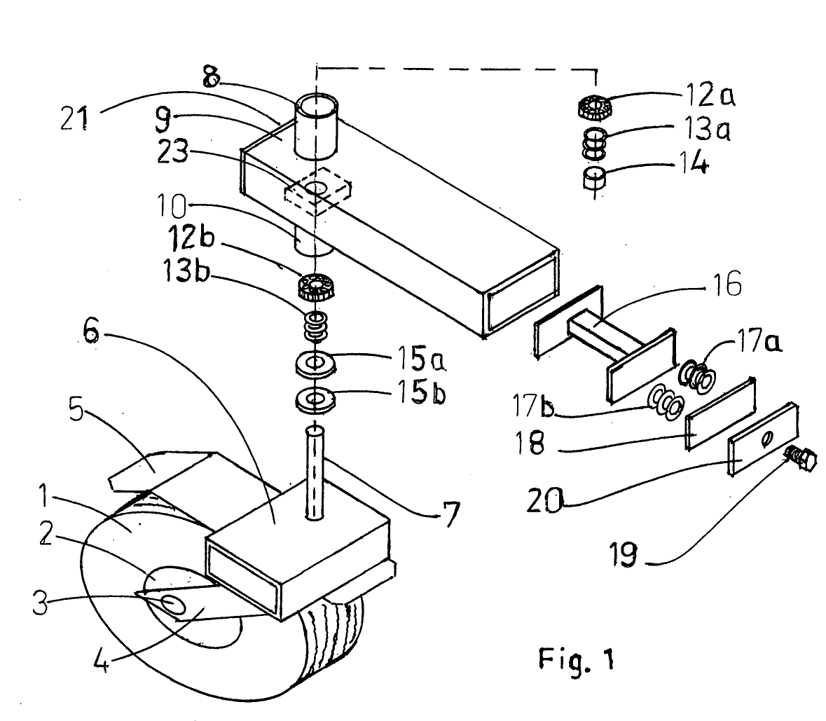

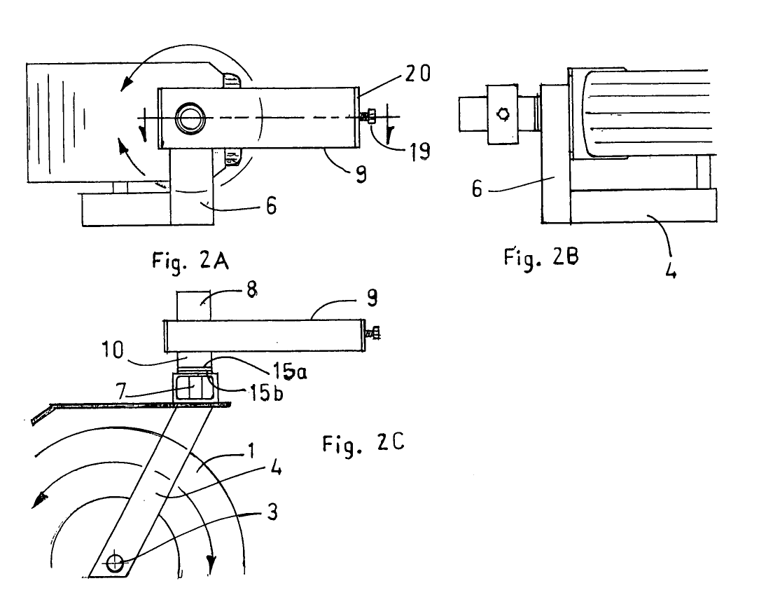

Referring to FIG. 1, illustrated are the main component parts of the controlled caster wheel assembly as they are shown through an exploded assembly drawing. The wheel 1, hub 2 and spindle 3 components are of conventional design and may vary in size based upon carrying load and ground surface variations for which the total assembly operating conditions dictate. The wheel and hub component parts, 1 and 2 as illustrated in FIG. 2C, are of conventional design illustrating wheel rotation. The hub spindle support tube 4 comprised of tubular material attaches to hub spindle 3 and wheel/hub support housing 6 by suitable means such as welding. Wheel fender 5 is illustrated as an attachment only and is of conventional design and availability. The main support spindle 7 attaches to the main support housing 6 by suitable means such as welding and as illustrated in FIG. 2A, is the pivotal center for rotation of the caster wheel. Thus, allowing free, full 360 degree rotation of caster wheel, both clockwise and counterclockwise.

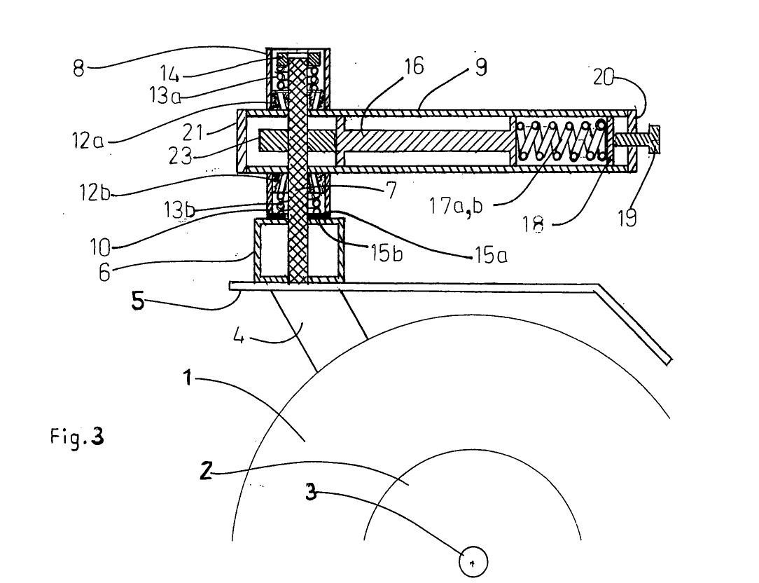

The encapsulated main support spindle 7 illustrated in both, FIG. 1 and FIG. 3, extends through clutch plates 15a and 15b, lower compression spring 13b, lower taper roller bearing 12b, lower bearing housing 10, cam/cam follower housing 9, cam 23, upper bearing housing 8, upper taper roller bearing 12a, upper compression spring 13a, and is attached to clutch and bearing tensioning cap 14 by suitable means such as welding or thread fit. Clutch plate 15b is allowed to rotate freely and clutch plate 15a is attached to lower bearing housing 10 by suitable means such as welding. As illustrated also, cam 23 is adjusted to provide increased spring compression when caster begins to steer from normal line of direction and then is fastened to main support spindle 7 by suitable means such as welding and is encapsulated within cam/cam follower housing 9. Upper and Lower bearing support housings, 8 and 10 are also attached to cam/cam follower housing 9 by suitable means such as welding.

Referring now to FIGS. 1 and 3, the cam follower 16, compression springs 17a and 17b, spring adjustment plate 18 are inserted inside of the cam/cam follower support housing 9 as illustrated. Adjusting screw cap 20 and rear end cap 21 are then attached to cam/cam follower housing 9 by suitable means such as welding. Adjusting screw 19 is threaded through adjusting screw cap 20 and is tightened against actuator adjustment plate 18 thus setting proper compression on cam follower actuators 17a and 17b.

The following description is considered as an illustration only of the principles of the invention. The controlled caster wheel invention will be sized according to the necessary weight it must carry and at which speed the wheel must travel by given conditions of end use. This invention is applicable to all uses of caster wheel designs.

What is claimed is:

1. A controlled caster wheel assembly comprising: a caster beam assembly which rotates about a main support spindle encapsulated within an upper bearing housing, a cam/cam follower support housing, a cam, a cam follower, a cam follower actuator, a lower bearing housing, a weight sensitive clutch.

2. The apparatus of claim 1 wherein a spring loaded bearing support about the said main support spindle with an upper and lower bearing housing, an upper and lower taper roller bearing, an upper and lower compression spring, clutch and bearing tensioning cap.

3. The apparatus of claim 1 wherein a weight sensitive clutch having an upper clutch plate, a lower clutch plate.

4. The apparatus of claim 1 wherein a cam, with at least one flat side, attached to said main support spindle.

5. The apparatus of claim 1 wherein a cam/cam follower support housing comprising an encapsulated main support spindle, a cam follower.

6. The apparatus of claim 1 wherein a cam follower housing comprises a cam follower actuator, an actuator adjustment plate, an adjusting screw, an adjusting screw cap.
